(19) United States
(12) Patent Application Publication
(10) Pub. No.: US 2008/0099000 A1
(43) Pub. Date: May 1, 2008

(54) PCV valve

(75) Inventors: Koichi Suzuki, Obu-shi (JP); Mamoru Tateishi, Kariya-shi (JP); Katsumi Ishida, Toyoake-shi (JP); Hiroshi Asanuma, Chita-shi (JP); Hirokazu Konohara, Inazawa-shi (JP); Hideto Ide, Chita-shi (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, OBU-SHI (JP)

(21) Appl. No.: 11/907,226

(22) Filed: Oct. 10, 2007

(30) Foreign Application Priority Data
Oct. 30, 2006 (JP) 2006-293643
Nov. 2, 2006 (JP) 2006-298698

(51) Int. Cl. F02B 25/00

(52) U.S. Cl. 123/574

(57) ABSTRACT

A PCV valve include a housing which internally has a valve chamber including an entrance at one end and an exit at the other end in an axial direction of the valve chamber. In the valve chamber, a valve element which is axially movable and a spring which urges the valve element toward the entrance are provided. An electric heater is provided in the housing. The valve element includes an end which is movable close to the entrance. The electric heater is arranged in such a manner as to surround the valve chamber from the exit to the end of the valve element closer to the entrance. The electric heater includes a cylindrical bobbin made of a high heat-conductive material and a coil wound on the outer periphery of the bobbin. The bobbin has an inner peripheral surface forming a large part of an inner peripheral surface of the valve chamber.

### BACKGROUND OF THE INVENTION

1. Field of the Invention

The present invention relates to a blow-by gas returning device to return blow-by gas, leaked from an engine combustion chamber to a crankcase, to an engine intake system, thereby preventing discharge of the blow-by gas into the atmosphere, and to a PCV (Positive Crankcase Ventilation) valve provided in the device.

2. Description of Related Art

Conventionally, as this type of technique, devices disclosed in Japanese Published Unexamined Utility Model Applications Nos. 61-122313(1986), 4-117129(1992) and 60-98709(1985) are known. JP '313 discloses a structure in which a valve case includes a valve chamber and an electric heater is provided on the outer periphery of the valve case.

Further, JP '129 discloses a structure in which a PCV valve is provided in a blow-by system connected to an engine intake system. An electric heater is incorporated in the PCV valve and a temperature sensor for detecting ambient air temperature is provided in the PCV valve. A controller controls power application to (energization of) the electric heater based on the temperature detected with the temperature sensor.

However, in the device disclosed in JP '313, it is unclear about the position of the valve case in which the electric heater is placed. The electric heater is provided in the valve case for the purpose of preventing freezing of a valve element and a valve seat provided in the valve chamber and associated parts such as a spring. It is therefore necessary to determine the position of the electric heater so as to effectively prevent freezing of the valve element movable in an axial direction. Accordingly, the problem is the placement of the electric heater to heat the valve element and the valve seat provided in the valve chamber and associated parts with high efficiency.

On the other hand, in the device disclosed in JP '313, the occurrence of an abnormality of power application, in which power is continuously applied to the electric heater or an overcurrent flows through the electric heater due to a trouble of the controller or the like, is conceivable. In this case, there is a probability of overheating in the electric heater in addition to power application loss in the electric heater. Accordingly, it is necessary to handle such power application abnormality not on the controller side but on the PCV valve side.

### BRIEF SUMMARY OF THE INVENTION

The present invention has been made in view of the above circumstances and has an object to provide a PCV valve capable of effectively preventing freezing of at least a valve element.

Another object of the present invention is providing a PCV valve capable of preventing power application loss and overheating upon occurrence of power application abnormality.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a PCV valve comprising: a housing internally having a valve chamber, the valve chamber including an entrance at one end and an exit at the other end in an axial direction of the valve chamber; a valve seat forming the exit; a valve element placed in such a manner as to be axially movable within the valve chamber relative to the valve seat; and an electric heater provided in the housing; wherein the electric heater is arranged in such a manner as to surround the valve chamber from the exit to a vicinity of the entrance.

According to another aspect, the present invention provides a PCV valve comprising: a housing internally having a valve chamber, the valve chamber including an entrance at one end and an exit at the other end in an axial direction of the valve chamber; a valve seat forming the exit; a valve element placed in such a manner as to be axially movable within the valve chamber relative to the valve seat; and an electric heater provided in the housing; wherein the electric heater includes a cylindrical member and an electric heating device placed on an outer periphery of the cylindrical member, and the electric heater is integrally formed with the housing in such a manner as to surround the valve chamber from the exit to a vicinity of the entrance.

According to another aspect, the present invention provides a PCV valve comprising: a housing internally having a valve chamber, the valve chamber including an entrance at one end and an exit at the other end in an axial direction of the valve chamber; a valve seat forming the exit; a valve element placed in such a manner as to be axially movable within the valve chamber relative to the valve seat; a spring provided with a first end and interposed between a wall forming the valve seat and the valve element to urge the valve element toward the entrance; and an electric heater provided in the housing; wherein the wall forming the valve seat, with which the first end of the spring is in contact, is made of a heat-conductive member with high heat-conductivity, and the electric heater is arranged in such a manner as to surround the heat-conductive member.

According to another aspect, the present invention provides a PCV valve comprising: a housing internally having a valve chamber, the valve chamber including an entrance at one end and an exit at the other end in an axial direction of the valve chamber; a valve seat forming the exit; a valve element placed in such a manner as to be axially movable within the valve chamber relative to the valve seat; a spring provided with a first end and a second end and interposed between a wall forming the valve seat and the valve element to urge the valve element toward the entrance; and an electric heater provided in the housing; wherein the wall of the exit, with which the first end of the spring is in contact, is made of a heat-conductive member with high heat-conductivity, and the electric heater is arranged in such a manner as to surround the heat-conductive member, and the first end of the spring is engaged with the wall forming the valve seat and the second end of the spring is engaged with the valve element.

According to another aspect, the present invention provides a PCV valve comprising an electric heater and a power application wiring for power application to the electric heater, wherein the PCV valve further comprises a power-application interrupting device arranged to interrupt the power application in the power application wiring before overheating of the electric heater upon occurrence of an abnormality of power application.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a sectional view of a PCV valve of a first embodiment, mounted on an engine main body;

FIG. 2 is a sectional front view of a spring of the first embodiment;

FIG. 3 is a plan view of the spring of the first embodiment;

FIG. 4 is a plan view of an electric heater of the first embodiment;

FIG. 5 is a sectional view of the electric heater taken along a line A-A in FIG. 4;

FIG. 6 is a front view of the electric heater of the first embodiment;

FIG. 7 is a sectional view of a PCV valve of a second embodiment;

FIG. 8 is a side view showing a relation of a valve seat, a valve element, and a spring, including a partial cutaway view, in a third embodiment;

FIG. 9 is a sectional front view of a spring of a third embodiment;

FIG. 10 is a sectional view of a PCV valve of another embodiment, mounted on an engine main body;

FIG. 11 is a sectional view of a PCV valve of a fourth embodiment, mounted on an engine main body;

FIG. 12 is a front view of assembly of an electric heater of the fourth embodiment;

FIG. 13 is a sectional view of the electric heater of the fourth embodiment, taken along a line A-A in FIG. 12;

FIG. 14 is a plan view of assembly of an electric heater of a fifth embodiment;

FIG. 15 is a sectional view of the electric heater of the fifth embodiment, taken along a line B-B in FIG. 14;

FIG. 16 is a sectional view of a PCV valve of a sixth embodiment, mounted on an engine main body;

FIG. 17 is a sectional view of a PCV valve of a seventh embodiment, mounted on an engine main body;

FIG. 18 is a sectional view of a PCV valve of an eighth embodiment, mounted on an engine main body; and

FIG. 19 is a sectional view of a PCV valve of a ninth embodiment, mounted on an engine main body;

### DETAILED DESCRIPTION OF THE PREFERRED EMBODIMENTS

### First Embodiment

A detailed description of a first embodiment of a PCV valve of the present will now be given referring to the accompanying drawings.

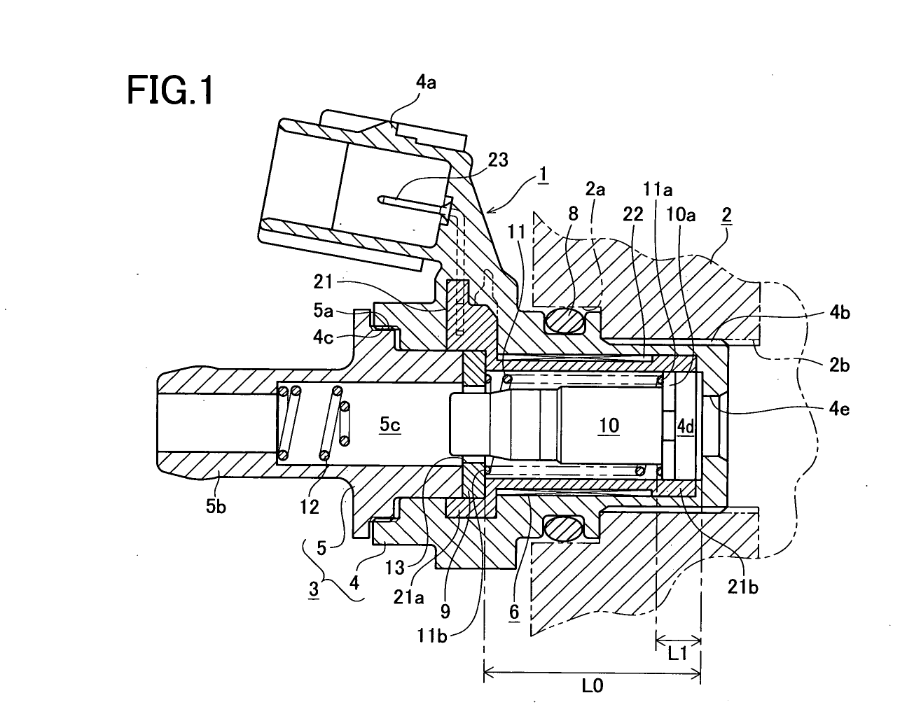

FIG. 1 is a sectional view of a PCV valve 1 of the present embodiment mounted on an engine main body 2. As it is well known, the PCV valve 1 is provided in a blow-by gas returning device to return blow-by gas, leaked from an engine combustion chamber to a crankcase, to an engine intake system, thereby preventing discharge of the blow-by gas into the atmosphere. As shown in FIG. 1, the PCV valve 1 has a resin housing 3 having a hollow shape. The housing 3 is formed with mutually assembled main housing 4 and sub housing 5.

The main housing 4 includes a connector 4a formed in its upper part, an assembly of an electric heater 6 integrally provided inside, and a seal ring 8 attached to an outer periphery of the main housing 4. The sub housing 5 is assembled with the main housing 4 by threadedly engaging external screw-threads 5a formed on the periphery of one end portion of the sub housing 5 into internal screw-threads 4c formed in one end of the main housing 4. Otherwise, the sub housing 5 may be assembled with the main housing 4 by press-inserting one end of the sub housing 5 into the end of the main housing 4 and ultrasonic-welding them. The other end of the sub housing 5 is employed as a pipe joint 5b. The housing 3 is mounted in a mounting hole 2a of the engine main body 2 by threadedly engaging external screw-threads 4b formed on the outer periphery of the other end of the main housing 4 into internal screw-threads 2b of the attachment hole 2a.

A hollow portion of the main housing 4 forms a valve chamber 4d of the present invention. The valve chamber 4d includes an entrance 4e at its one end (a right end in FIG. 1) in its axial direction. The entrance 4e, formed on one end wall of the main housing 4, communicates with the engine main body 2 side. The sub housing 5 includes a hollow portion 5c communicating with the valve chamber 4d of the main housing 4. The valve chamber 4d and the hollow portion 5c form in combination a blow-by gas passage. A valve seat 9 having a ring shape is held between the main housing 4 and the sub housing 5. The valve seat 9 corresponds to a heat-conductive member of the present invention with high heat conductivity, and is formed of, e.g., metal. In the valve chamber 4d, a valve element 10 is provided movably in the axial direction, in correspondence with the valve seat 9. The valve element 10, formed with non-magnetic material such as SUS in an approximately column shape, is provided movably through the valve seat 9. The valve element 10 has a shape in which its distal end has a stepwisely-reduced diameter. Accordingly, when the valve element 10 is displaced in the axial direction, the width of a clearance (opening) between the valve seat 9 and the valve element 10 is changed. The clearance between the valve seat 9 and the valve element 10 forms an exit 13 of the valve chamber 4d positioned at the other end (a left end in FIG. 1) of the valve chamber 4d in the axial direction.

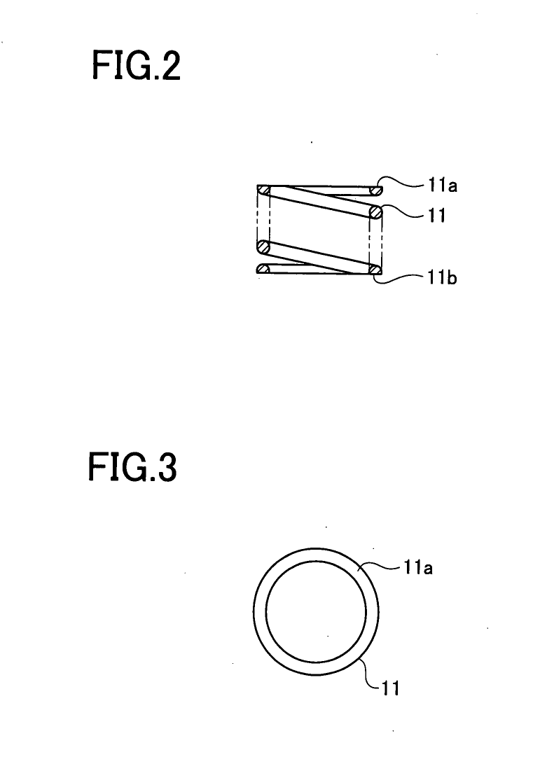

The valve element 10 includes a flange 10a at its rear end, i.e., an end on the entrance side positioned around the entrance 4e. The flange 10a is placed so that its outer peripheral surface is slidable on an inner peripheral surface of the valve chamber 4d, and the flange 10a corresponds to a sliding member of the present invention. The flange 10a includes a notch to allow passing of blow-by gas. A compression spring 11 is installed between the valve seat 9 and the flange 10a. The compression spring 11 urges the valve element 10 toward the entrance 4e of the valve chamber 4d. FIG. 2 is a sectional view of the compression spring 11. FIG. 3 is a plan view of the compression spring 11. In the compression spring 11, a first end (a right end in FIG. 1) 11a and a second end (a left end in FIG. 1) 11b respectively have a flat surface. Further, a contact portion of the flange 10a with which the first end 11a of the compression spring 11 is in contact has a flat surface and similarly a contact portion of the valve seat 9 with which the second end 11b of the compression spring 11 is in contact has a flat surface. Further, the distal end of the valve element 10 is insertable into the hollow portion 5c of the sub housing 5 through the valve seat 9. In the hollow portion 5c of the sub housing 5, another compression spring 12 is installed in such a manner as to be contactable with the distal end of the valve element 10.

In a mounting state shown in FIG. 1, upon engine operation, an intake negative pressure acts on the hollow portion 5c of the sub housing 5 through a pipe from the engine intake system. Further, the blow-by gas filled inside the engine main body 2 enters into the valve chamber 4d of the main housing 4 through the entrance 4e, and a gas pressure in the valve chamber 4d acts on the valve element 10. In this manner, the intake negative pressure and the gas pressure act on the valve element 10 against the urging force of the compression spring 11, thereby moving the valve element 10 toward the valve seat 9, thus changing the clearance between the valve seat 9 and the valve element 10 (the size of the exit 13). With the change of the clearance, the flow rate of the blow-by gas passing from the valve chamber 4d of the main housing 4 to the hollow portion 5c of the sub housing 5, i.e., the flow rate of the blow-by gas measured in the PCV valve 1 is controlled. As the distal end of the valve element 10 is brought into contact with the compression spring 12 in the hollow portion 5c of the sub housing 5, the movement of the valve element 10 is restricted.

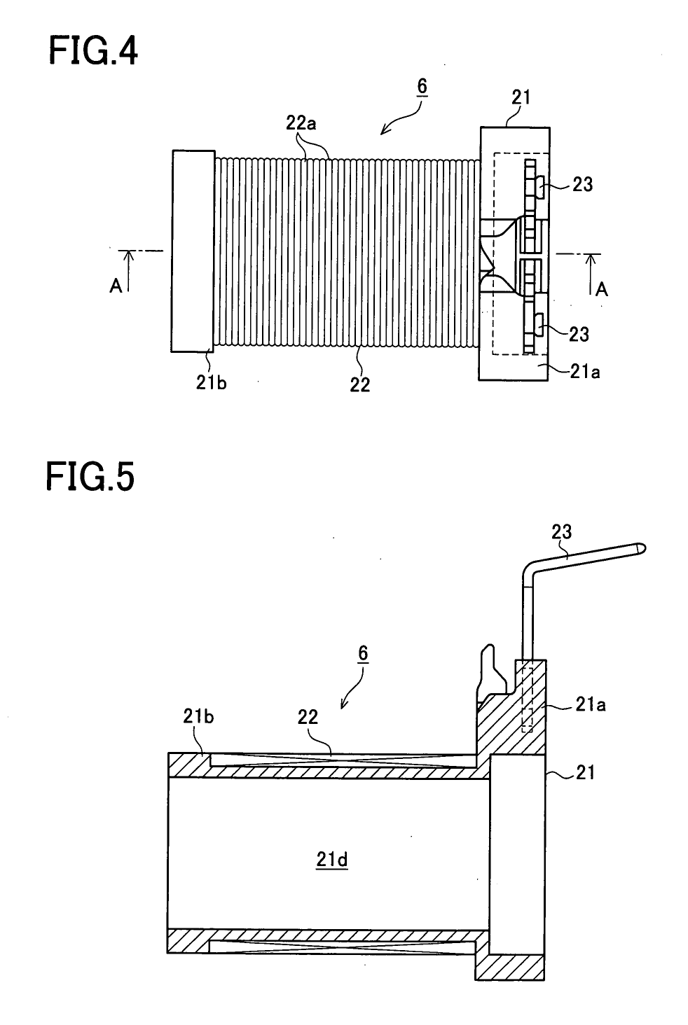

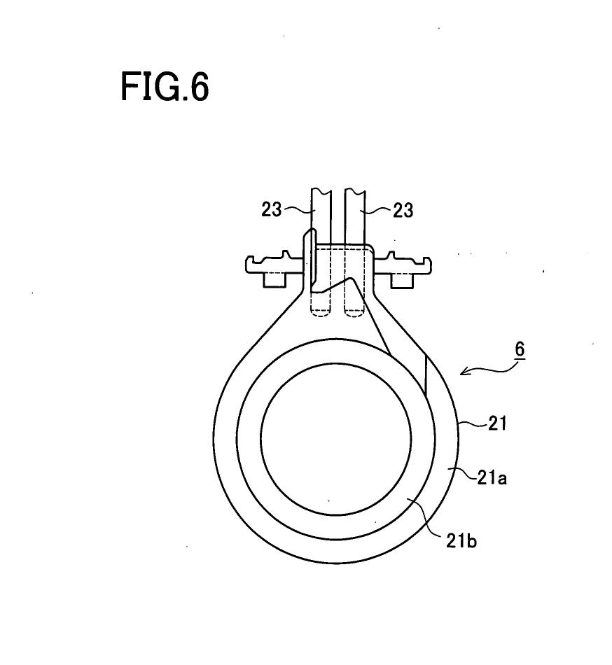

Next, the structure of the electric heater 6 will be described in detail. FIG. 4 is a plan view showing the assembly of the electric heater 6. FIG. 5 is a sectional view of the electric heater 6 taken along a line A-A in FIG. 4. FIG. 6 is a front view of the electric heater 6. This electric heater 6 is placed inside the main housing 4. The assembly of the electric heater 6 includes a bobbin 21 having a cylindrical shape with a large flange 21a and a small flange 21b on both ends in its axial direction, a coil 22 having a wire 22a wound around the outer periphery of the bobbin 21, and a pair of connection terminals 23 provided on the large flange 21a. The bobbin 21 which corresponds to a cylindrical member of the present invention is made of a material with high heat conductivity. Such high heat-conductive materials may include inorganic filler compounded resin, metal and the like. The coil 22, which corresponds to an electric heating device of the present invention, is able to generate heat upon application of power. The wire 22a of the coil 22 is formed of a nichrome wire, a copper nickel wire or the like. The rear ends of the respective connection terminals 23 are electrically connected to the coil 22. As shown in FIG. 1, the distal ends of the respective connection terminals 23 are projected into the connector 4a.

The electric heater 6 is insert-molded in the main housing 4. That is, upon resin molding of the main housing 4, the assembly of the electric heater 6 having the above structure is inserted in a metal mold, and molten resin is poured in the metal mold. The assembly of the electric heater 6 is wrapped with the molten resin and the resin is solidified, thus the main housing 4 as an integrated composite part is formed. As shown in FIG. 1, the assembly of the electric heater 6 is located in the center of the main housing 4, and a hollow portion 21d of the bobbin 21 of the electric heater 6 forms a large part of the valve chamber 4d of the main housing 4. Thus the inner peripheral surface of the bobbin 21 forms a large part of the inner peripheral surface of the valve chamber 4d of the main housing 4. Further, the valve seat 9 is integrally formed in the main housing 4 so that the valve seat 9 is fitted in the large flange 21a of the bobbin 21 and in contact with the inner peripheral surface of the large flange 21a. Further, the electric heater 6 is provided in the valve chamber 4d in such a manner as to surround the valve chamber 4d from the exit 13 to the vicinity of the entrance 4e. More specifically, as shown in FIG. 1, when the valve element 10 is placed in its initial position by the urging force of the compression spring 11, the electric heater 6 surrounds the valve chamber 4d at least from the exit 13 to the flange 10a of the valve element 10.

The length of the bobbin 21 of the electric heater 6 is approximately the same as that of the valve chamber 4d in the axial direction. In FIG. 1, assuming that the entire area of the inner peripheral surface of the valve chamber 4d is “L0”, the inner peripheral surface of the valve chamber 4d includes a high contact area denoted by “L1” with high frequency of contact with the flange 10a near the entrance 4e. The high contact area L1 means an area with which the outer periphery of the flange 10a is brought into contact with high frequency while the valve element 10 is returned to the initial position. In this embodiment, the inner peripheral surface of the bobbin 21 of the electric heater 6 forms the inner peripheral surface of the valve chamber 4d, and only the small flange 21b of the bobbin 21 stands in the high contact area L1, but the coil 22 does not overlap with the high contact area L1. With this arrangement, the coil 22 of the electric heater 6 overlaps with the inner peripheral surface of the valve chamber 4d except the high contact area L1.

An external connector (not shown) is connected to the connector 4a of the main housing 4 shown in FIG. 1. The external connector is electrically connectable to the connection terminals 23. The external connector is connected to a controller (not shown) via an external wiring (not shown) to control the electric heater 6.

In the above-described PCV valve 1 of the present embodiment, the blow-by gas in the engine main body 2 enters in the valve chamber 4d of the main housing 4 through the entrance 4e, and flows out through the exit 13 and the hollow portion 5c of the sub housing 5 to the outside. The outflow amount of the blow-by gas from the exit 13 is determined by the opening between the valve element 10 moving in the valve chamber 4d and the valve seat 9. The electric heater 6 is provided from the exit 13 to the vicinity of the entrance 4e, or more specifically, from the exit 13 to the flange 10a of the valve element 10, so as to surround the valve chamber 4d. Accordingly, in addition to the valve seat 9 at the exit 13 from which the blow-by gas flows out, the valve element 10 and the compression spring 11 positioned in the valve chamber 4d are respectively warmed by heat generated by the electric heater 6. The valve element 10 moves in the axial direction in the valve chamber 4, however, most of the valve chamber 4d as a moving range of the valve element 10 and the flange 10a are warmed with the electric heater 6. Accordingly, the moving valve element 10 can be infallibly warmed with the electric heater 6. In the PCV valve 1, freezing of the valve seat 9 can be effectively prevented, and freezing of the valve element 10 and the compression spring 11 can also be effectively prevented.

According to the present embodiment, as the electric heater 6 is assembled in the main housing 4 through the bobbin 21, the assembly workability can be improved. That is, it is not necessary to directly assemble the coil 22 serving as an electric heating device in the main housing 4. Further, the bobbin 21 on which the coil 22 is wounded is insert-molded in the main housing 4 so that the electric heater 6 is integrally formed in the main housing 4. Accordingly, the electric heater 6 can be easily assembled in the main housing 4. Thus the productivity of the PCV valve 1 having the electric heater 6 can be improved. Further, the bobbin 21 is made of a high heat-conductive material, and the inner peripheral surface of the bobbin 21 forms a large part of the inner peripheral surface of the valve chamber 4d. Accordingly, heat generation of the coil 22 can be excellently transmitted via the bobbin 21 to the valve chamber 4d. In this meaning, the valve element 10 and the compression spring 11 can be more easily warmed with the heat generated by the electric heater 6. Thus, the effect of preventing freezing of the valve seat 9, the valve element 10 and the compression spring 11 can be improved.

Further, according to the present embodiment, the wall on the exit 13 side with which the second end 11b of the compression spring 11 provided in the valve chamber 4d is brought into contact is formed with the valve seat 9 having high conductivity. Further, the large flange 21a of the bobbin 21 as a part of the electric heater 6 is arranged around the valve seat 9. Further, the compression spring 11 urges the valve element 10 toward the entrance 4e of the valve chamber 4d. Accordingly, the heat generated by the electric heater 6 is directly transmitted to the valve seat 9, and transmitted to the spring 11 via the valve seat 9, and transmitted to the flange 10a of the valve element 10 via the compression spring 11. In this meaning, the effect of prevention of freezing of the valve seat 9 can be further improved, and in addition, the effect of prevention of freezing of the compression spring 11, the valve element 10 and the flange 10a can be improved.

Further, according to the present embodiment, the first end 11a and the second end 11b of the compression spring 11 provided in the valve chamber 4d and the contact portions of the valve seat 9 and the flange 10a of the valve element 10 in contact with the first and second ends 11a and 11b respectively have a flat surface. Accordingly, the contact areas between the compression spring 11 and the valve seat 9 and between the spring 11 and the flange 10a is are increased, and the effect of heat conduction between the compression spring 11, and the valve seat 9 and the flange 10a is increased. In this meaning, the effect of prevention of freezing of the compression spring 11 and the flange 10a of the valve element 10 can be further improved.

Further, according to the present embodiment, as the valve element 10 is made of a non-magnetic material, an electromagnetic force which acts on the valve element 10 from the coil 22 upon power application to the electric heater 6 is reduced. Accordingly, operation failure of the valve element 10 by the influence of the electromagnetic force can be prevented. That is, as the electromagnetic force which acts on the valve element 10 upon power application to the electric heater 6 is reduced, the moving amount of the valve element 10 (displacement amount) is not influenced. Accordingly, the flow rate of blow-by gas in the PCV valve 1 can be maintained unchanged between during non-power application and during power application to the electric heater 6.

According to the present embodiment, the coil 22 of the electric heater 6 overlaps with the inner peripheral surface of the valve chamber 4d except the high contact area L1, but does not overlap with the high contact area L1 in the inner peripheral surface of the valve chamber 4d. Accordingly, the abrasion of the bobbin 21 due to frequent contact with the flange 10a does not directly influence the coil 22. In this meaning, the damage to the electric heater 6 (coil 22) due to the abrasion by contact with the flange 10a can be reduced, and the durability of the electric heater 6 can be improved.

### Second Embodiment

Next, a second embodiment of the PCV valve of the present invention will be described in detail with reference to the accompanying drawings.

Note that in the following second and third embodiments, components identical to those in the first embodiment will be given the same reference numerals and the explanations thereof will be omitted. The following explanation is made with a focus on the differences from the first embodiment.

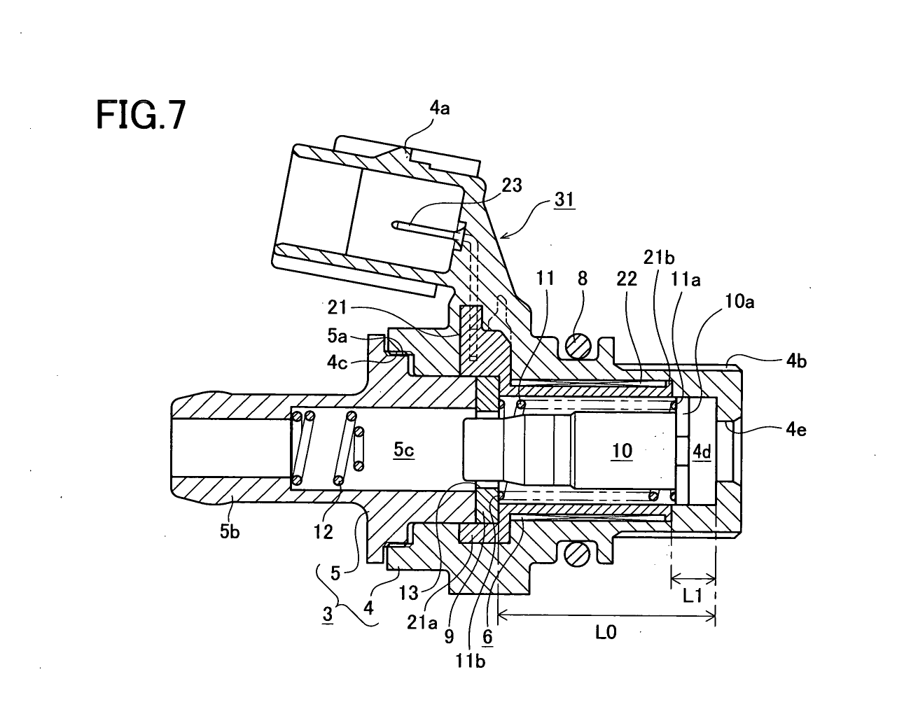

In a PCV valve 31 of the present embodiment, the size of the electric heater 6 in the valve chamber 4d is different from that in the first embodiment. FIG. 7 is a sectional view of the PCV valve 31 of the present embodiment. In the present embodiment, the length of the bobbin 21 of the electric heater 6 is somewhat shorter than that in the first embodiment, relative to the length of the valve chamber 4d in the axial direction. That is, in FIG. 7, assuming that the entire area of the inner peripheral surface of the valve chamber 4d is “L0”, the inner peripheral surface of the valve chamber 4d includes the high contact area L1, with which the frequency of contact with the flange 10a is high, around the entrance 4e. In the present embodiment, the inner peripheral surface of the bobbin 21 of the electric heater 6 forms the inner peripheral surface of the valve chamber 4d. In addition, the bobbin 21 is somewhat shorter than the bobbin 21 of the first embodiment such that the bobbin 21 does not stand in the high contact area L1. With this arrangement, the inner peripheral surface of the bobbin 21 of the electric heater 6 forms the inner peripheral surface of the valve chamber 4d except the high contact area L1.

According to the present embodiment, the inner peripheral surface of the bobbin 21 of the electric heater 6 forms the inner peripheral surface of the valve chamber 4d except the high contact area L1. Accordingly, the valve element 10 and the compression spring 11 are warmed by heat generated by the electric heater.6, and the valve element 10 including the flange 10a is warmed with the heat generated by the electric heater 6. Thus, the freezing of the valve element 10 and the spring 11 in addition to the valve seat 9 can be effectively prevented. Further, the bobbin 21 of the electric heater 6 does not stand in the high contact area L1 in the inner peripheral surface of the valve chamber 4d. Accordingly, the abrasion of the electric heater 6, i.e., the bobbin 21, caused by contact with the flange 10a can be reduced. In this meaning, the damage to the electric heater 6 (bobbin 21) due to abrasion caused by contact with the flange 10a can be reduced, and the durability of the electric heater 6 can be improved by the reduction of the damage. Further, the operation failure of the valve element 10 due to the abrasion can be prevented, and in this meaning, the durability of the PCV valve 11 can be improved. The other operations and advantages are the same as those obtained in the first embodiment.

### Third Embodiment

Next, a third embodiment of the PCV valve of the present invention will be described in detail with reference to the accompanying drawings.

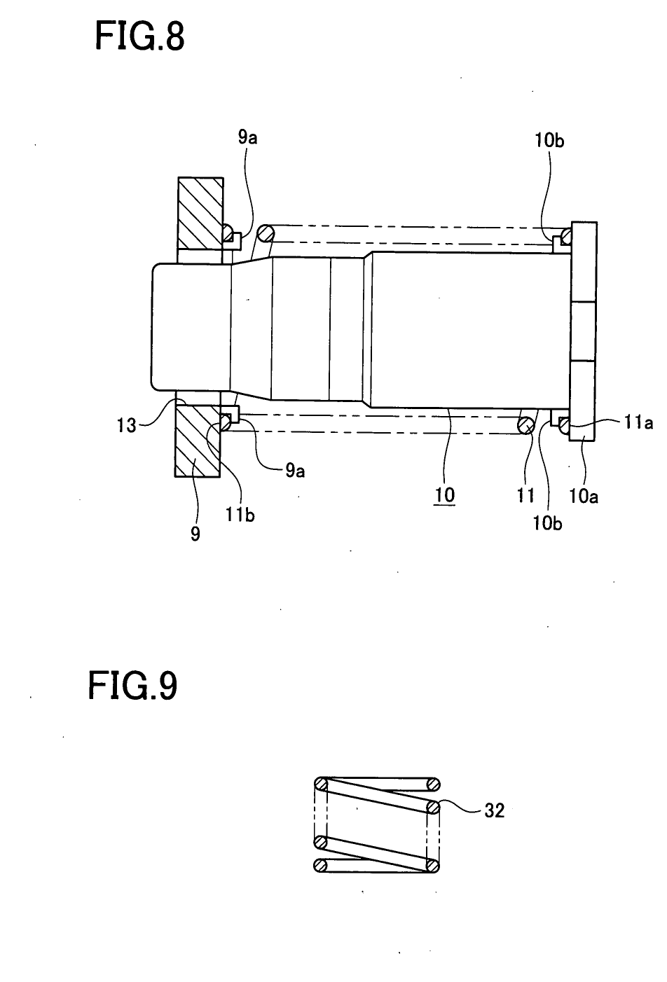

In the PCV valve of the present embodiment, the difference from the above-described embodiments is the relation among the valve seat 9, the valve element 10, and the compression spring 11. FIG. 8 is a partially cutaway side view showing the relation among the valve seat 9, the valve element 10, and the compression spring 11. In the present embodiment, the difference from the first embodiment is that the second end 11b of the compression spring 11 is engaged with a hook 9a formed in the wall of the valve seat 9, and the first end 11a of the compression spring 11 is engaged with a hook 10b formed in the flange 10a of the valve element 10.

According to the present embodiment, the second end 11b of the compression spring 11 is engaged with the valve seat 9, and the first end 11a of the compression spring 11 is engaged with the flange 10a. Accordingly, heat conduction from the valve seat 9 to the compression spring 11 and the heat conduction from the spring 11 to the flange 10a of the valve element 10 can be maintained. That is, the flat surfaces of the both ends 11a and 11b of the compression spring 11 are in contact with, and not away from, the flat surfaces of the valve seat 9 and the flange 10a, and the heat conduction between the ends 11a and 11b, and the valve seat 9 and the flange 10a, can always be maintained. Accordingly, freezing of the valve seat 9, the valve element 10 and the compression spring 11 can be effectively prevented. Especially, the effect of prevention of freezing of the valve element 10, the compression spring 11 and the flange 10a can be further improved. The other operations and advantages are the same as those obtained in the first embodiment.

### Fourth Embodiment

Next, a fourth embodiment of the PCV valve of the present invention will be described in detail with reference to the accompanying drawings.

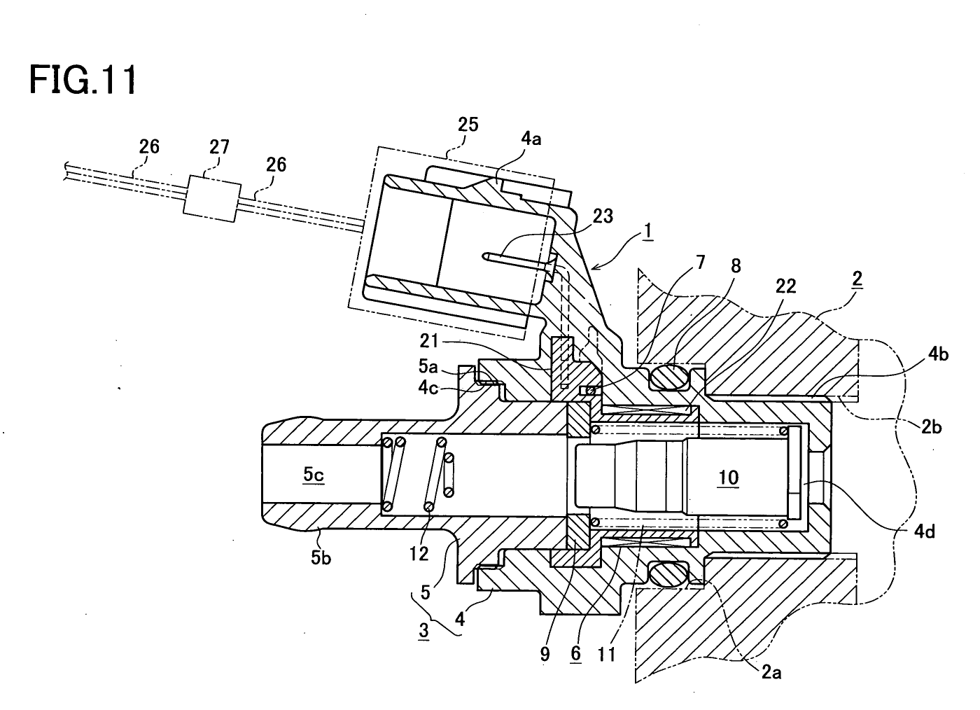

FIG. 11 is a sectional view showing the PCV valve 1 of the present embodiment attached to the engine main body 2. In FIG. 11, the respective numerals denote components identical to those having the same numerals in FIG. 1. In the following description, the detailed explanations of those components will be omitted, and the difference will be mainly described.

In the present embodiment, the difference from the above-described first to third embodiments is that a temperature fuse 7 is incorporated in the electric heater 6.

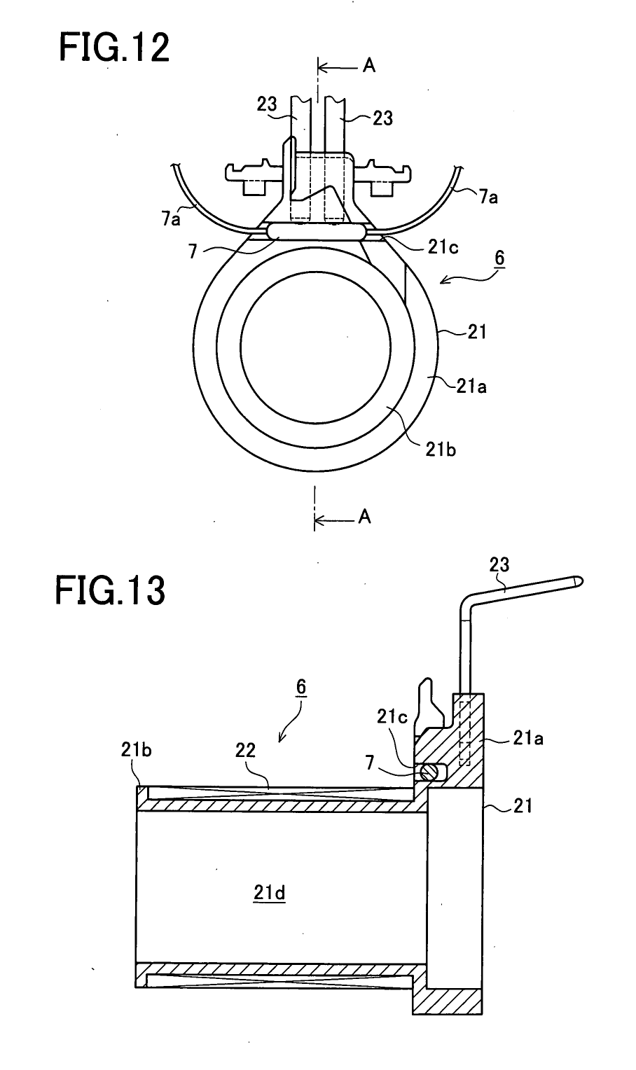

Next, the structure of the electric heater 6 will be described in detail. FIG. 12 is a front view of the assembly of the electric heater 6. FIG. 13 is a sectional view of the electric heater 6 taken along a line A-A in FIG. 12. The electric heater 6 provided inside the main housing 4 includes the bobbin 21 having the large flange 21a and the small flange 21b on both ends in the axial direction, a recess 21c formed in the large flange 21a, the coil 22 wound around the outer periphery of the bobbin 21, and the pair of connection terminals 23 provided in the large flange 21a. The rear ends of the respective connection terminals 23 are electrically connected to the coil 22. The distal ends of the respective connection terminals 23 are projected in the connector 4a as shown in FIG. 11. The temperature fuse 7 is built in the recess 21c of the large flange 21a. The recess 21c is formed in a horizontal groove shape opening in one side surface of the large flange 21a, and the temperature fuse 7 is fitted in the recess 21c. Lead wires 7a extended from the both ends of the temperature fuse 7 are lead out to the outside from the both ends of the recess 21c. These lead wires 7a are directly connected to the connection terminals 23 and the coil 22 of the electric heater 6. The connection terminals 23, the temperature fuse 7 and the coil 22 are electrically serially connected. As the lead wires 7a are directly connected to the coil 22, the heat generated by the electric heater 6 (coil 22) is directly transmitted to the temperature fuse 7 via the lead wires 7a.

In this manner, in the status where the temperature fuse 7 is built in the recess 21c of the large flange 21a, the electric heater 6 and the temperature fuse 7 are insert-molded in the main housing 4. That is, upon resin molding of he main housing 4, the assembly of the electric heater 6 having the above structure is inserted in a metal mold, and molten resin is poured in the metal mold. The assembly of the electric heater 6 is wrapped with the molten resin and the resin is solidified, thus the main housing 4 as an integrated composite part is formed. As shown in FIG. 11, the assembly of the electric heater 6 is provided in the center of the main housing 4. The hollow portion 21d of the bobbin 21 of the electric heater 6 forms a part of the valve chamber 4d of the main housing 4. That is, the inner peripheral surface of the bobbin 21 forms a part of the inner peripheral surface of the valve chamber 4d.

As shown in FIG. 11, an external connector 25 is connected to the connector 4a of the main housing 4. The external connector 25 is electrically connectable to the connection terminals 23. An external wiring 26 is connected to the external connector 25. One end of the external wiring 26 is connected to a controller (not shown) to control the electric heater 6. A power application switch 27 which is turned ON/OFF by the controller is provided somewhere on the external wiring 26 to control power application to the electric heater 6.

When the temperature fuse 7 is overheated by receiving the heat generated by of the electric heater 6, power application is interrupted in the external wiring 26 and the connection terminals 23. As an example, the temperature fuse 7 is formed by joining fusible alloy between the both lead wires 7a, applying special resin mainly containing rosin around a fusible element so as to maintain fusing over a long term, inserting the resin-coated fusible element into a ceramic tube, and sealing the both ends of the tube with epoxy resin to maintain airtightness. In the above manner, the temperature fuse 7 is formed. As the operation principle of the temperature fuse 7, when the fusible element reaches the fusing point and is fused by temperature rise of ambient air temperature, the surface tension of the alloy is promoted by the action of the special resin applied on the surface, and is condensed to the sides of the lead wires 7a on both ends, thus the fusible element is segmentized.

In the above structure, the connection terminals 23, the external connector 25 and the external wiring 26 correspond to power application wirings of the present invention. (Hereinafter, the connection terminals 23, the external connector 25 and the external wiring 26 will be referred to as “power application wirings 23, 25 and 26”.) Further, the temperature fuse 7 corresponds to a power-application interrupting device of the present invention to interrupt power application in the power application wirings 23, 25 and 26 prior to overheating in the electric heater 6 upon occurrence of the abnormality of power application.

In the above-described PCV valve 1 of the present embodiment, blow-by gas in the engine main body 2 enters the valve chamber 4d of the main housing 4, and flows out from the clearance between the valve seat 9 and the valve element 10 via the hollow portion 5c of the sub housing 5 to the outside. The outflow amount of the blow-by gas is determined by the opening between the valve element 10 and the valve seat 9. The electric heater 6 is provided from the vicinity of the valve seat 9 to around an intermediate portion of the valve chamber 4d so as to surround the valve chamber 4d. Accordingly, by power application to the electric heater 6, the valve element 10 and the compression spring 11 positioned in the valve chamber 4d, in addition to the valve seat 9, are warmed by heat generated by the electric heater 6. As a result, in the PCV valve 1, freezing of the valve seat 9, the valve element 10 and the compression spring 11 can be prevented.

According to the PCV valve 1 of the present embodiment, upon occurrence of the abnormality of power application, the power application is interrupted in the power application wirings 23, 25 and 26 with the temperature fuse 7 prior to overheating in the electric heater 6. Accordingly, the power application to the electric heater 6 is stopped and thus the heat generation of the electric heater 6 is stopped. As a result, even when the abnormality of power application occurs, power application loss and overheating in the electric heater 6 can be prevented.

As the abnormality of power application, continuous power application that an electric current continuously flows through the power application wirings 23, 25 and 26 is conceivable. In the present embodiment, the temperature fuse 7 is provided in the PCV valve 1. Accordingly, when an abnormality of power application such as continuous power application has occurred in the electric heater 6, the temperature fuse 7 is overheated by excessive heat generated by the electric heater 6, thereby interrupting the power application in the power application wirings 23, 25 and 26. Then, the power application to the electric heater 6 is stopped, and the heat generation of the electric heater 6 is stopped. As a result, the abnormality of power application such as the continuous power application can be remedied.

According to the present embodiment, as the temperature fuse 7 is provided in the large flange 21a of the electric heater 6, i.e., the temperature fuse 7 is provided in a position close to the electric heater 6, the temperature fuse 7 easily receives the heat generated by the electric heater 6. Accordingly, the contact between the temperature fuse 7 and the electric heater 6 can be simplified. Especially, in the present embodiment, as the lead wires 7a receive the heat generated by the electric heater 6, the heat generated by the electric heater 6 is directly transmitted via the lead wires 7a to the temperature fuse 7, and the temperature 7 is easily heated. Accordingly, the operation response of the temperature fuse 7 can be improved, and use of another heat-conductive member to transmit the heat generated by the electric heater 6 to the temperature fuse 7 can be omitted. Further, in the present embodiment, the temperature fuse 7 is insert-molded in the main housing 4 so that the temperature fuse 7 is integrally formed inside the main housing 4, so that it is not necessary to attach the temperature fuse 7 to the main housing 4. Especially, in the present embodiment, the temperature fuse 7 is fitted in the recess 21c of the large flange 21a of the bobbin 21 of the electric heater 6 and hence the exclusive space of the large flange 21a can be effectively utilized. Further, since the temperature fuse 7 and the electric heater 6 are insert-molded in the main housing 4, the temperature fuse 7 is formed, together with the electric heater 6, inside the main housing 4. This enables compact installation of the temperature fuse 7 in the main housing 4 with reduced labor and protects the temperature fuse 7.

### Fifth Embodiment

Next, a fifth embodiment of the PCV valve of the present invention will be described in detail with reference to the accompanying drawings.

Note that in the following embodiments (including the fifth embodiment), components identical to those in the fourth embodiment have the same reference numerals and the explanations thereof will be omitted, and differences will be mainly described below.

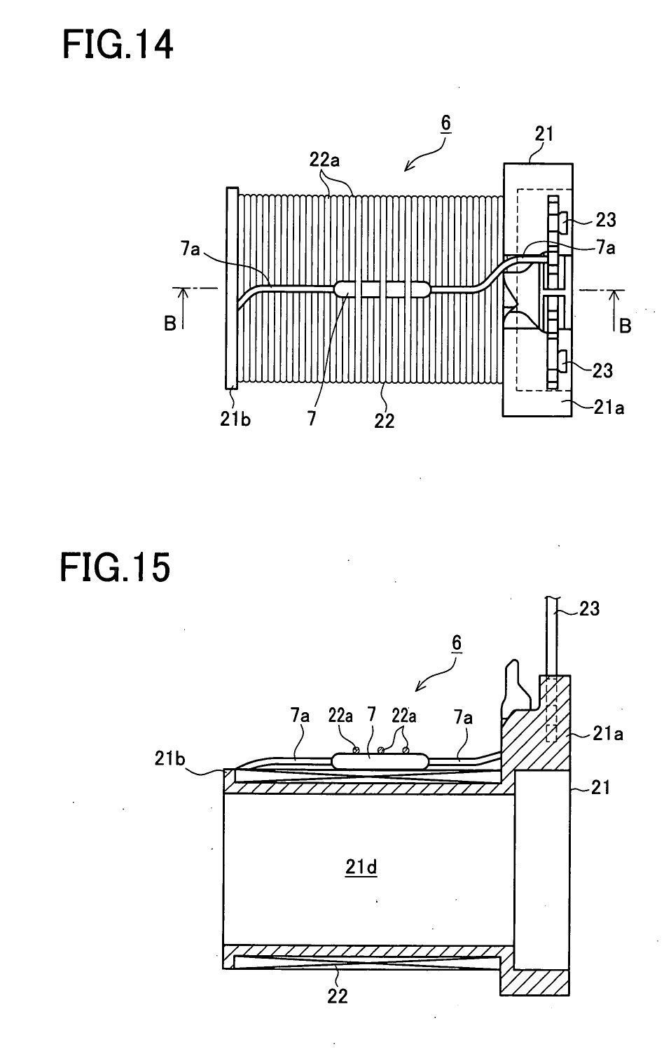

FIG. 14 is a plan view of the assembly of the electric heater 6 provided in the PCV valve of the present embodiment. FIG. 15 is a sectional view of the electric heater 6 taken along a line B-B in FIG. 14. In the present embodiment, the difference from the fourth embodiment is the attachment of the temperature fuse 7 to the electric heater 6. That is, in the present embodiment, the temperature fuse 7 is assembled, with the coil 22, on the bobbin 21. The temperature fuse 7 is placed on the coil 22 wound around the bobbin 21, and bound to the coil 22 with the wire 22a of the coil 22 wound several times, thus assembled in the coil 22. The pair of lead wires 7a of the temperature fuse 7 are respectively directly connected to the connection terminals 23 and the coil 22. In this status, the electric heater 6 and the temperature fuse 7 are insert-molded in the main housing 4. The other components are the same as those in the fourth embodiment.

According to the present embodiment, the temperature fuse 7 is provided on the coil 22 of the electric heater 6, so that the heat generated by the electric heater 6 can be transmitted more easily to the temperature fuse 7. Accordingly, the contact between the temperature fuse 7 and the electric heater 6 can be simplified, and the operation response of the temperature fuse 7 can be improved. Further, the temperature fuse 7 is assembled with the coil 22 on the bobbin 21 of the electric heater 6, and hence the exclusive space of the electric heater 6 can be effectively utilized. Further, the temperature fuse 7 and the electric heater 6 are insert-molded in the main housing 4, the temperature fuse 7 is integrally formed, together with the electric heater 6, inside the main housing 4. It is therefore unnecessary to attach the temperature fuse 7 to the main housing 4 later. Accordingly, in the present embodiment, it is also possible to enable compact installation of the temperature fuse 7 in the main housing 4 with reduced labor and protect the temperature fuse 7. The other operations and advantages are the same as those obtained in the fourth embodiment.

### Sixth Embodiment

Next, a sixth embodiment of the PCV valve of the present invention will be described in detail with reference to the accompanying drawings.

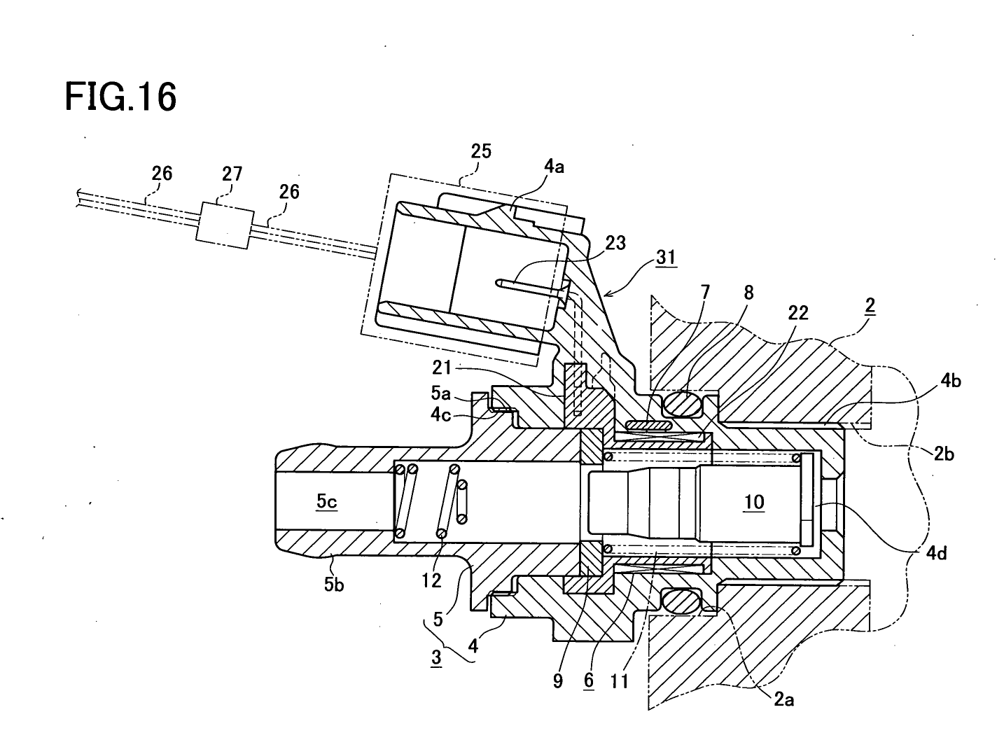

FIG. 16 is a sectional view of a PCV valve 31 of the present embodiment attached to the engine main body 2. In the present embodiment, the difference from the fourth embodiment is that the temperature fuse 7 is insert-molded in the main housing 4 in a position close to the coil 22 of the electric heater 6. That is, in the present embodiment, the temperature fuse 7 is insert-molded inside the main housing 4 in such a manner as to be away from the electric heater 6. The pair of lead wires (not shown) of the temperature fuse 7 are respectively connected to the connection terminals 23 and the coil 22. Accordingly, in the present embodiment, it is also possible to obtain the same operations and advantages as those obtained in the fourth embodiment.

### Seventh Embodiment

Next, a seventh embodiment of the PCV valve of the present invention will be described in detail with reference to the accompanying drawings.

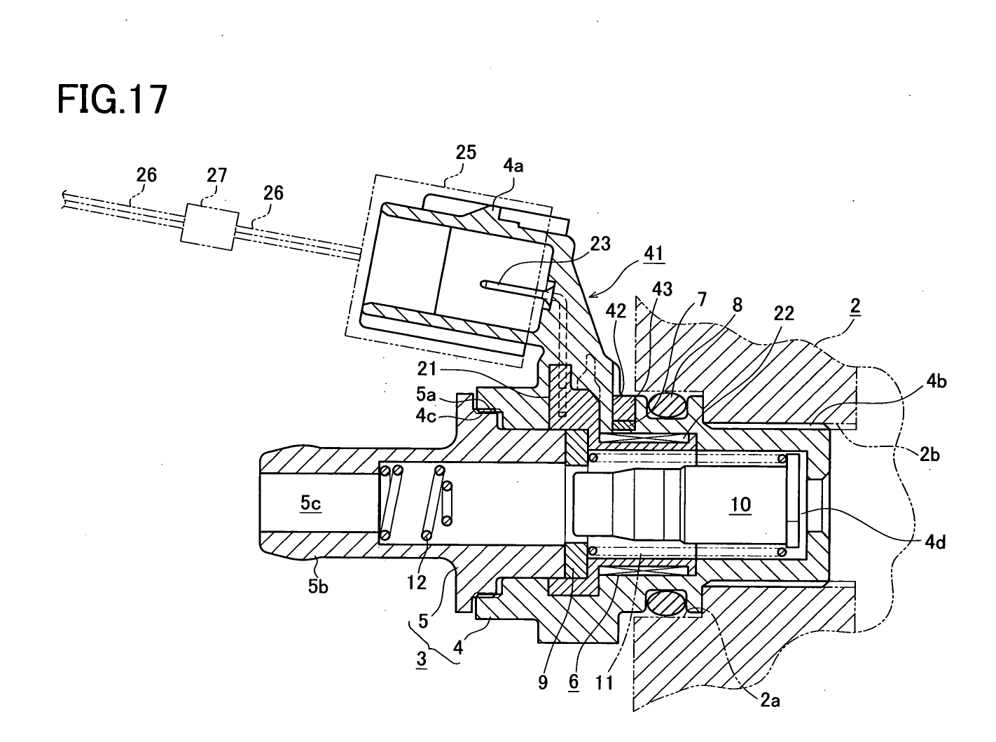

FIG. 17 is a sectional view of a PCV valve 41 of the present embodiment mounted in the engine main body 2. In the present embodiment, the difference from the above-described respective embodiments is the attachment of the temperature fuse 7 to the main housing 4. That is, in the present embodiment, a recess 42 is formed in the outer surface of the main housing 4 in a position close to the coil 22 of the electric heater 6, and a bottom wall of the recess 42 is closest to the coil 22. The temperature fuse 7 is fitted in the recess 42, and a potting material 43 as a filling material is filled over the temperature fuse 7 so that the temperature fuse 7 is embedded in the main housing 4. The lead wires (not shown) of the temperature fuse 7 are connected to the connection terminals 23 and the coil 22. It may be arranged such that the lead wires of the temperature fuse 7 are respectively connected to only the connection terminals 23, and the temperature fuse 7 is brought into contact with the coil 22 via another heat-conductive member.

Also in the present embodiment, the temperature fuse 7 is provided in a position close to the coil 22 of the electric heater 6, so that the heat generated by the electric heater 6 can be easily transmitted to the temperature fuse 7. Accordingly; the contact between the temperature fuse 7 and the electric heater 6 can be simplified. Further, the temperature fuse 7 is fitted in the recess 42 in the outer surface of the main housing 4 and is embedded with the potting material 43, the temperature fuse 7 is integrally attached to the main housing 4 without insert-molding. This enables compact installation of the temperature fuse 7 in the main housing 4 with reduced labor and protects the temperature fuse 7. In the present embodiment, particularly, the temperature fuse 7 is not insert-molded in the main housing 4, needing no temperature control of the temperature fuse 7 during resin molding, allowing omission of the production labor corresponding to the above temperature control. The other operations and advantages are the same as those obtained in the above-described fourth to sixth embodiments.

### Eighth Embodiment

Next, an eighth embodiment of the PCV valve of the present invention will be described in detail with reference to the accompanying drawings.

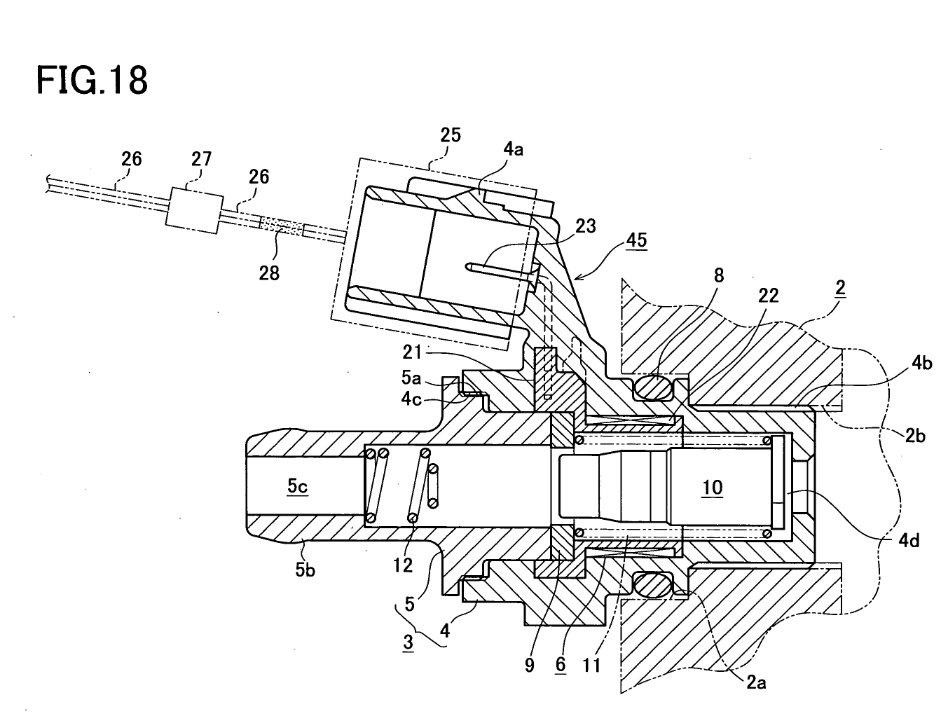

FIG. 18 is a sectional view of a PCV valve 45 of the present embodiment attached to the engine main body 2. In the present embodiment, the difference from the above-described fourth embodiment is that the temperature fuse 7 is omitted, and a current fuse 28 is provided in place of the temperature fuse 7.

That is, as shown in FIG. 18, the current fuse 28 is provided on the external wiring 26 between the power application switch 27 and the external connector 25. In the above-described embodiments, the temperature fuse 7 is overheated by receiving the heat generated by the electric heater 6 thereby power application is interrupted in the external wiring 26 and the connection terminals 23, whereas in the present embodiment using the current fuse 28, power application is interrupted in the external wiring 26 when a current that flows through the external wiring 26 changes. As an example, the current fuse 28 is formed with a self-reset type overcurrent protection device using a polymer PTC thermistor. The current fuse 28 interrupts power application when an overcurrent higher than a normal current flows. The current fuse 28 can be repeatedly used by removing an overcurrent factor. In the above structure, the current fuse 28 corresponds to the power-application interrupting device of the present invention to interrupt power application in the external wiring 26 prior to overheating in the electric heater 6 by the abnormality of power application.

According to the PCV valve 45 of the present embodiment, upon occurrence of power application abnormality, the power application is interrupted in the external wiring 26 with the current fuse 28 prior to overheating in the electric heater 6, thereby stopping the power application to the electric heater 6, and thus heat generation of the electric heater 6 is stopped. As a result, upon occurrence of power application abnormality, power application loss and overheating in the electric heater 6 can be prevented.

As power application abnormality, overcurrent power application that an overcurrent flows through the power application wirings 23, 25 and 26 is conceivable. In the present embodiment, the current fuse 28 is provided in the PCV valve 45. Accordingly, when the abnormality of power application such as overcurrent power application occurs in the electric heater 6, the current fuse 28 interrupts the power application in the power application wirings 23, 25 and 26 in response to an increase in current in the power application wirings 23, 25 and 26, thereby stopping the power application to the electric heater 6, and thus the heat generation of the electric heater 6 is stopped. As a result, the abnormality of power application such as overcurrent power application can also be handled.

In the present embodiment, since the current fuse 28 is provided in the middle of the external wiring. 26, it is unnecessary to provide the current fuse 28 in the housing 3. Accordingly, the current fuse 28 can be easily installed in comparison with a case where the current fuse 28 is provided in the housing 3.

### Ninth Embodiment

Next, a ninth embodiment of the PCV valve of the present invention will be described in detail with reference to the accompanying drawings.

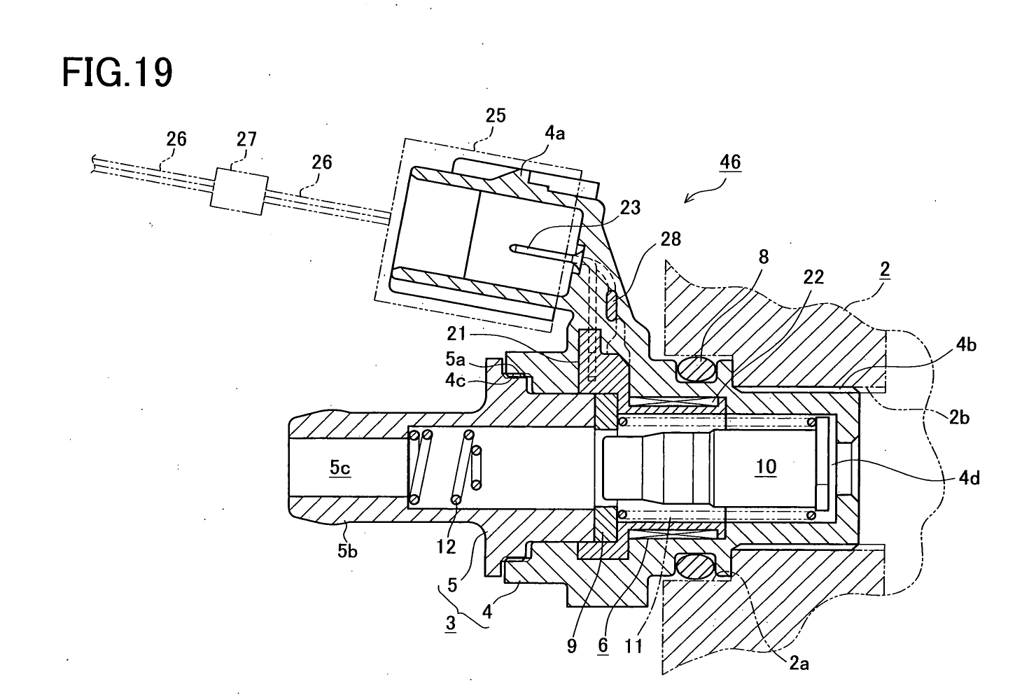

FIG. 19 is a sectional view of a PCV valve 46 of the present embodiment mounted in the engine main body 2. In the present embodiment, the difference from the above-described eighth embodiment is the attachment of the current fuse 28. That is, in the present embodiment, the current fuse 28 is not provided on the external wiring 26, but is insert-molded inside the main housing 4. The current fuse 28 is electrically connected to the connection terminals 23.

In the present embodiment, the current fuse 28 is insert-molded inside the main housing 4, the labor to provide the current fuse 28 on the external wiring 26 can be omitted. Further, the current fuse 28 can be protected with the main housing 4. The other operations and advantages are the same as those obtained in the eighth embodiment.

Note that the present invention is not limited to the above-described respective embodiments, but may be implemented as follows within the scope of the invention without departing from the subject matter of the invention.

In the above-described first to third embodiments, as a spring provided in the valve chamber 4d, the compression spring 11 having the both ends 11a and 11b formed with flat surfaces is used as shown in FIGS. 2 and 3. As shown in FIG. 9, a general spring 32 having both ends formed with nonflat surfaces may be used in place of the compression spring 11.

In the above-described first to third embodiments, the inner peripheral surface of the bobbin 21 of the electric heater 6 forms a part of the inner peripheral surface of the valve chamber 4d. It may be arranged such that the electric heater is embedded in the main housing so as to surround the valve chamber so that the electric heater does not form the inner peripheral surface of the valve chamber.

In the above-described first to third embodiments, the electric heating device of the electric heater 6 is formed of the coil 22 having the wire 22a, however, the electric heating device may be formed of a metal plate.

In the above-described first to third embodiments, the external screw-threads 4b of the main housing 4 are screwed in the internal screw-threads 2b of the mounting hole 2a of the engine main body 2 to mount the housing 4 i.e. the PCV valve 1 to the engine main body 2. However, the PCV valve may be mounted to the engine main body by another mounting manner using e.g. a quick connector or snap fitting.

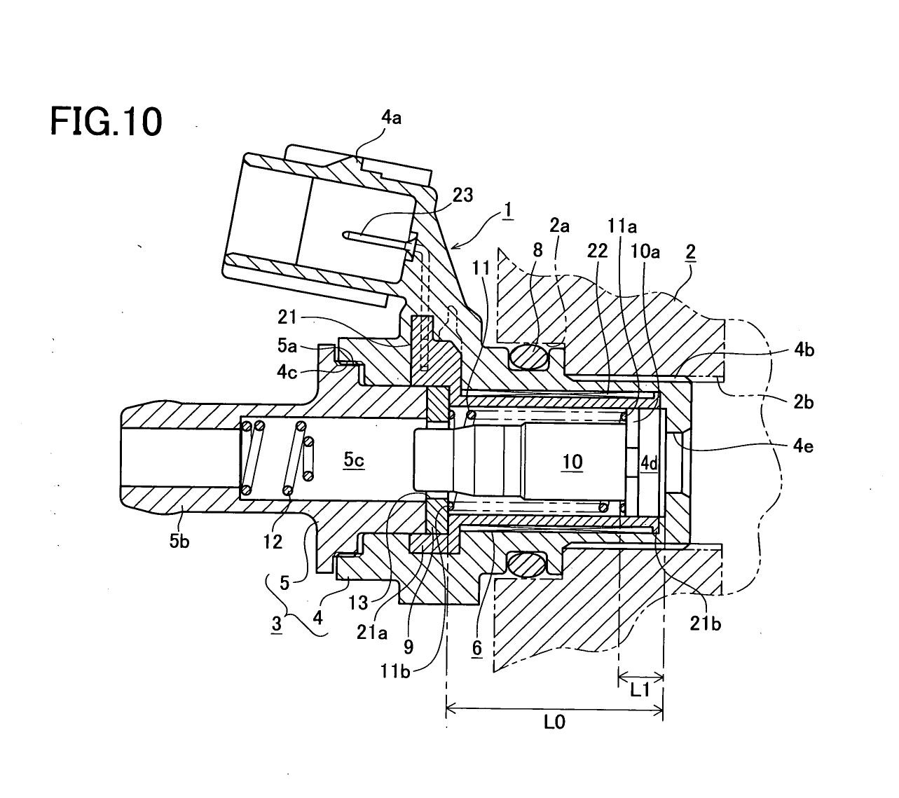

In the above-described first embodiment, only the small flange 21b of the bobbin 21 of the electric heater 6 stands in the high contact area L1 but the coil 22 does not overlap with the high contact area L1. However, it may be arranged such that as shown in FIG. 10, the small flange 21b of the bobbin 21 of the electric heater 6 stands in the high contact area L1 and a part of the coil 22 overlaps with the high contact area L1.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A PCV valve comprising:
a housing internally having a valve chamber,
the valve chamber including an entrance at one end and an exit at the other end in an axial direction of the valve chamber;
a valve seat forming the exit;
a valve element placed in such a manner as to be axially movable within the valve chamber relative to the valve seat; and
an electric heater provided in the housing;
wherein the electric heater is arranged in such a manner as to surround the valve chamber from the exit to a vicinity of the entrance.

2. The PCV valve according to claim 1, wherein
the PCV valve further comprises a spring which urges the valve element toward the entrance, and the valve element includes an end movable close to the entrance.

3. The PCV valve according to claim 1, wherein
the PCV valve further comprises a spring which urges the valve element toward the entrance; the valve element includes an end movable close to the entrance and includes a slidable portion which is formed at the end and slidable along an inner peripheral surface of the valve chamber; the inner peripheral surface of the valve chamber includes a high contact area close to the entrance, with high frequency of contact with the slidable portion of the valve element; and the electric heater is arranged to form an inner peripheral surface of the valve chamber excepting at least the high contact area.

4. The PCV valve according to claim 1, wherein
the electric heater includes a cylindrical member made of a high heat-conductive material and an electric heating device placed on an outer periphery of the cylindrical member, and the cylindrical member has an inner peripheral surface forming at least a part of the inner peripheral surface of the valve chamber.

5. The PCV valve according to claim 1, wherein the Valve element is made of a non-magnetic material.

6. The PCV valve according to claim 2, wherein
the electric heater includes a cylindrical member made of a high heat-conductive material and an electric heating device placed on an outer periphery of the cylindrical member, and the cylindrical member has an inner peripheral surface forming at least a part of the inner peripheral surface of the valve chamber.

7. The PCV valve according to claim 3, wherein
the electric heater includes a cylindrical member made of a high heat-conductive material and an electric heating device placed on an outer periphery of the cylindrical member, and the cylindrical member has an inner peripheral surface forming at least a part of the inner peripheral surface of the valve chamber.

8. A PCV valve comprising:
a housing internally having a valve chamber,
the valve chamber including an entrance at one end and an exit at the other end in an axial direction of the valve chamber;
a valve seat forming the exit;
a valve element placed in such a manner as to be axially movable within the valve chamber relative to the valve seat; and
an electric heater provided in the housing;
wherein the electric heater includes a cylindrical member and an electric heating device placed on an outer periphery of the cylindrical member, and the electric heater is integrally formed with the housing in such a manner as to surround the valve chamber from the exit to a vicinity of the entrance.

9. The PCV valve according to claim 8, wherein the cylindrical member has an inner peripheral surface forming at least a part of the inner peripheral surface of the valve chamber.

10. A PCV valve comprising:
a housing internally having a valve chamber,
the valve chamber including an entrance at one end and an exit at the other end in an axial direction of the valve chamber;
a valve seat forming the exit;
a valve element placed in such a manner as to be axially movable within the valve chamber relative to the valve seat;
a spring provided with a first end and interposed between a wall forming the valve seat and the valve element to urge the valve element toward the entrance; and
an electric heater provided in the housing;
wherein the wall forming the valve seat, with which the first end of the spring is in contact, is made of a heat-conductive member with high heat-conductivity, and the electric heater is arranged in such a manner as to surround the heat-conductive member.

11. A PCV valve comprising:
a housing internally having a valve chamber,
the valve chamber including an entrance at one end and an exit at the other end in an axial direction of the valve chamber;
a valve seat forming the exit;
a valve element placed in such a manner as to be axially movable within the valve chamber relative to the valve seat;
a spring provided with a first end and a second end and interposed between a wall forming the valve seat and the valve element to urge the valve element toward the entrance; and
an electric heater provided in the housing;
wherein the wall of the exit, with which the first end of the spring is in contact, is made of a heat-conductive member with high heat-conductivity, and the electric heater is arranged in such a manner as to surround the heat-conductive member, and the first end of the spring is engaged with the wall forming the valve seat and the second end of the spring is engaged with the valve element.

12. The PCV valve according to claim 10, wherein
the spring is provided with a second end, and
the first end and the second end of the spring have flat surfaces, and the wall forming the valve seat and a contact portion of the valve element with which the first end and the second end of the spring are respectively in contact have flat surfaces.

13. The PCV valve according to claim 11, wherein
the first end and the second end of the spring have flat surfaces, and the wall forming the valve seat and a contact portion of the valve element with which the first end and the second end of the spring are respectively in contact have flat surfaces.

14. A PCV valve comprising an electric heater and a power application wiring for power application to the electric heater,
wherein the PCV valve further comprises a power-application interrupting device arranged to interrupt the power application in the power application wiring before overheating of the electric heater upon occurrence of an abnormality of power application.

15. The PCV valve according to claim 14 wherein
the PCV valve further comprises a housing made of resin,
the electric heater is provided inside the housing, and
the power-application interrupting device is insert-molded in the housing, in a position close to the electric heater.

16. The PCV valve according to claim 14, wherein
the PCV valve further comprises a housing,
the electric heater is provided inside the housing,
the housing is formed, in an outer surface thereof, with a recess in a position close to the electric heater, and
the power-application interrupting device is fitted in the recess and embedded therein with a filling material.

17. The PCV valve according to claim 14, wherein
the PCV valve further comprises a housing made of resin,
the electric heater is provided inside the housing and includes a bobbin having a flange, a recess formed in the flange, and a coil provided on an outer periphery of the bobbin, and
the electric heater and the power-application interrupting device are insert-molded in the housing while the power-application interrupting device is fitted in the recess.

18. The PCV valve according to claim 14, wherein
the PCV valve further comprises a housing,
the electric heater is provided inside the housing and includes a bobbin and a coil provided on an outer periphery of the bobbin, and
the electric heater and the power-application interrupting device are insert-molded in the housing while the power-application interrupting device is assembled together with the coil on the bobbin.

19. The PCV valve according to claim 14,. wherein
the power-application interrupting device is a temperature fuse arranged to interrupt power application in the power application wiring by overheating by receiving heat generated by the electrical heater.

20. The PCV valve according to claim 19, wherein
the temperature fuse includes a lead wire connected to the power application wiring, and the lead wire receives the heat generated of the electric heater.

21. The PCV valve according to claim 14, wherein
the power-application interrupting device is a current fuse arranged to interrupt power application in the power application wiring when a current that flows through the power application wiring changes.

22. The PCV valve according to claim 14, wherein
the PCV valve further comprises a housing,
the power-application interrupting device is a current fuse arranged to interrupt power application in the power application wiring when a current that flows through the power application wiring changes,
the power application wiring includes a connection terminal of the electric heater and an external wiring connected to the connection terminal from outside of the housing, and
the current fuse is placed on a part of the external wiring.
